(19) United States
(12) Patent Application Publication
(10) Pub. No.: US 2017/0272236 A1
(43) Pub. Date: Sep. 21, 2017

(54) ENCRYPTING APPARATUS AND METHOD USING LOGICAL COMPLEMENT VALUES FOR ENHANCED SECURITY AGAINST SIDE CHANNEL ANALYSIS

(71) Applicant: Electronics and Telecommunications Research Institute, Daejeon (KR)

(72) Inventors: Seung Kwang LEE, Daejeon (KR); Doo Ho CHOI, Cheonan (KR)

(21) Appl. No.: 15/414,490

(22) Filed: Jan. 24, 2017

(30) Foreign Application Priority Data
Mar. 18, 2016 (KR) 10-2016-0032742

(51) Int. Cl. H04L 9/06; G06F 12/14

(52) U.S. Cl. CPC H04L 9/0618; G06F 12/1408; G06F 2212/1052

(57) ABSTRACT

An encrypting apparatus includes a storage unit and a controller.

The storage unit stores an encryption algorithm including an internal function outputting a second value from a first value and an inversion mode encryption algorithm including an inversion mode internal function outputting a complement of the second value from a complement of the first value.

The controller selects one of an inversion mode and a non-inversion mode. The controller outputs a cipher text from a plain text using the encryption algorithm when the non-inversion mode is selected.

### CROSS-REFERENCE TO RELATED APPLICATION

This application claims priority to and the benefit of Korean Patent Application No. 10-2016-0032742 filed in the Korean Intellectual Property Office on Mar. 18, 2016, the entire contents of which are incorporated herein by reference.

### BACKGROUND OF THE INVENTION

(a) Field of the Invention

The present invention relates to an encrypting apparatus and method using logical complement values for enhanced security against a side channel analysis.

(b) Description of the Related Art

An analysis method for an encrypting operation apparatus using a side channel analysis is an analysis method for acquiring secret information such as an encryption key by analyzing power consumption or electromagnetic waves that are generated from security electronic devices performing an encryption algorithm.

In more detail, the analysis method is a method for revealing a secret key by analyzing a Hamming weight (or a Hamming distance or a correlation between specific bits) of a key-dependent estimated intermediate value and power measurement values, when a plurality of power waveforms are collected during a performance of a cryptographic operation.

That is, the encrypting operation apparatus is to extract the secret information within the encrypting operation apparatus using leak information such as the power consumption and the electromagnetic waves that are generated while the encrypting operation is performed.

Therefore, for enhanced security against a side channel analysis, a development for an encrypting method for decreasing or removing, by an attacker, a correlation among an estimated intermediate value, a power value, or the like using a correct secret key has been demanded.

The above information disclosed in this Background section is only for enhancement of understanding of the background of the invention and therefore it may contain information that does not form the prior art that is already known in this country to a person of ordinary skill in the art.

### SUMMARY OF THE INVENTION

The present invention has been made in an effort to provide an encrypting apparatus and method using logical complement values for enhanced security against a side channel analysis having advantages of preventing a secret key from being revealed by the side channel analysis by eliminating a correlation between an intermediate value and a power measurement value.

Meanwhile, objects of the present disclosure are not limited to the above-mentioned objects. That is, other objects that are not mentioned may be obviously understood by those skilled in the art to which the present invention pertains.

An exemplary embodiment of the present invention provides an encrypting apparatus, including: a storage unit storing an encryption algorithm including an internal function outputting a second value from a first value and an inversion mode encryption algorithm including an inversion mode internal function outputting a complement of the second value from a complement of the first value; and a controller selecting one of an inversion mode and a non-inversion mode, outputting a first cipher text from a plain text using the encryption algorithm when the non-inversion mode is selected, and outputting a complement plain text that is the complement of the plain text from the plain text, outputting a complement cipher text from the complement plain text using the inversion mode encryption algorithm, and outputting a second cipher text that is a complement of the complement cipher text from the complement cipher text, when the inversion mode is selected.

Further, a method for outputting a complement cipher text from a plain text without a process of outputting the complement plain text of the plain text in the inversion mode may also be included. The number of cases of outputting a complement intermediate value of the next step from the complement plain text and outputting the complement intermediate value of the next step from the plain text in the inversion mode may also be included.

The controller may randomly select one of the inversion mode and the non-inversion mode.

The probability that the controller selects the inversion mode and the probability that the controller selects the non-inversion mode may be the same.

The storage unit may store a look-up table of the internal function and the controller may output the first cipher text from the plain text using the look-up table.

The storage unit may store a look-up table of the inversion mode internal function and the controller may output the complement cipher text from the complement plain text or from the plain text using the look-up table or a series of look-up tables.

Another embodiment of the present invention provides an encrypting method of an encrypting apparatus, including: selecting one of a non-inversion mode and an inversion mode; outputting a first cipher text from a plain text using an encryption algorithm including an internal function that outputs a second value from a first value, when the non-inversion mode is selected; outputting a complement plain text that is a complement of the plain text from the plain text, when the inversion mode is selected; outputting a complement cipher text from the complement plain text using an inversion mode encryption algorithm that includes an inversion mode internal function outputting a complement of the second value from a complement of the first value; and outputting a second cipher text that is a complement of the complement cipher text from the complement cipher text.

In the selecting of any one of the inversion mode and the non-inversion mode, one of the inversion mode and the non-inversion mode may be randomly selected.

The probability that the inversion mode may be selected and the probability that the non-inversion mode may be selected are the same.

In the outputting of the first cipher text from the plain text, the first cipher text may be output from the plain text using the look-up table of the internal function.

In the outputting of the complement cipher text from the complement plain text, the complement cipher text may be output from the complement plain text using the look-up table of the inversion mode internal function.

### BRIEF DESCRIPTION OF THE DRAWINGS

The following drawings accompanying in the present specification illustrate a preferred embodiment of the present invention and serves to better understand the technical idea of the present invention with the detailed description of the present invention. Therefore, the present invention should not be construed only to the matters described with reference to the drawings.

FIG. 1 is a block diagram illustrating an encrypting apparatus for enhanced security against a side channel analysis according to an exemplary embodiment of the present invention.

FIG. 2 is an exemplified diagram illustrating a look-up table of an internal function according to the exemplary embodiment of the present invention.

FIG. 3 is an exemplified diagram illustrating a look-up table of an inversion mode internal function according to an exemplary embodiment of the present invention.

FIG. 4 is a flow chart of an encrypting method for enhanced security against a side channel analysis according to an exemplary embodiment of the present invention.

FIG. 5 is a process of encrypting a plain text to be encrypted into a cipher text according to an exemplary embodiment of the present invention.

FIG. 6 is a block diagram illustrating a computing system executing the encrypting method for enhanced security against a side channel analysis according to an exemplary embodiment of the present invention.

### DETAILED DESCRIPTION OF THE EMBODIMENTS

Hereinafter, some exemplary embodiments in the present specification will be described in detail with reference to the illustrative drawings. In adding reference numerals to components of each drawing, even though the same components are illustrated in different drawings, it is to be noted that these components are denoted by same reference numerals if possible. Further, in describing exemplary embodiments of the present invention, well-known functions or constructions will not be described in detail since they may unnecessarily obscure the understanding of the present invention.

In describing components of the present specification, terms such as first, second, A, B, (a), (b), etc. may be used. These terms are used only to differentiate the components from other components. Therefore, the nature, times, sequence, etc. of the corresponding components are not limited by these terms. Further, unless indicated otherwise, it is to be understood that all the terms used in the specification including technical or scientific terms have the same meaning as those that are generally understood by those who skilled in the art. It must be understood that the terms defined by the dictionary generally used are identical with the meanings within the context of the related art, and they should not be ideally or excessively formally defined unless the context clearly dictates otherwise.

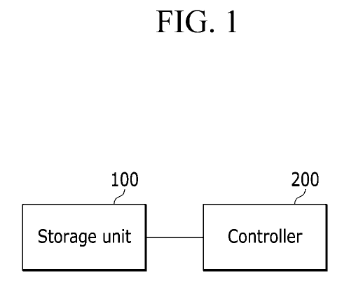

FIG. 1 is a block diagram illustrating an encrypting apparatus for enhanced security against a side channel analysis according to an exemplary embodiment of the present invention.

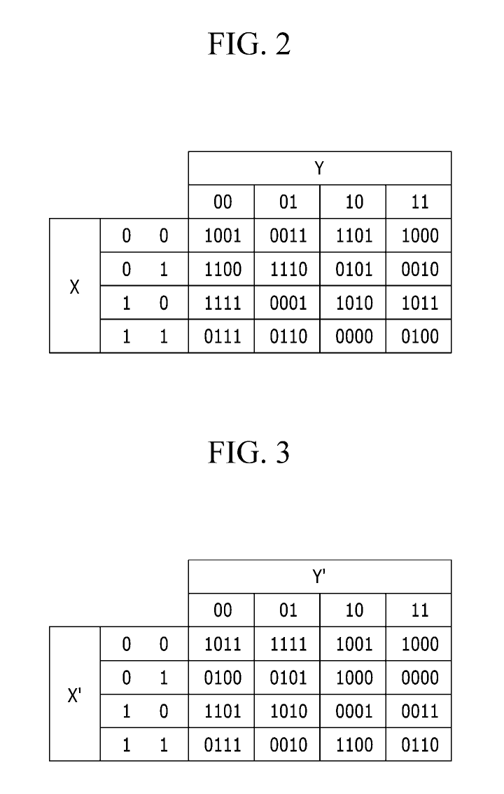

Further, FIG. 2 is an exemplified diagram illustrating a look-up table of an internal function according to the exemplary embodiment of the present invention. FIG. 3 is an exemplified diagram illustrating a look-up table of an inversion mode internal function according to an exemplary embodiment of the present invention.

Referring to FIG. 1, the encrypting apparatus may include a storage unit 100, a controller 200, or the like.

However, the components illustrated in FIG. 1 are not essential, and therefore the encrypting apparatus that includes components more or fewer than those may also be implemented.

First, the storage unit 100 is configured to store an encryption algorithm required when encryption is performed.

Here, the encryption algorithm is an algorithm for outputting a cipher text from a plain text and may include a plurality of internal functions. For example, an AES algorithm may include internal functions called AddRoundKey, SubBytes, ShiftRows, and MixColumns. The internal functions can be implemented using a series of pre-computed look-up tables and the look-up tables can be encoded for some security purpose.

The present invention performs encryption to decrease a correlation between an intermediate value and a power value that are output during an encryption process for preventing an attack of a side channel, and therefore the storage unit 100 stores an inversion mode encryption algorithm including an inversion mode internal function for an inversion mode.

When the internal function of the encryption algorithm outputs a second value from a first value, the inversion mode internal function of the inversion mode encryption algorithm outputs a complement of the second value from a complement of the first value.

For example, when the first value represented by a binary number is 10001 and the second value is 11100, the complement of the first value is 01110 and the complement of the second value is 00011. When the internal function outputs 11100 from 10001, the inversion mode internal function outputs 00011 from 01110.

Describing it by expression, if x represents the first value, y represents the second value, x′ represents the complement of the first value, y′ represents the complement of the second value, Sbox represents the internal function of the encryption algorithm, and Sbox′ represents the inversion mode internal function of the inversion mode encryption algorithm, when y=Sbox (x), y′=Sbox′ (x′).

The storage unit 100 may store the internal function of the encryption algorithm and the inversion mode internal function of the inversion mode encryption algorithm as a look-up table or a series of look-up tables.

Referring to FIGS. 2 and 3, the input first value is two as x and y and the output second value is described in the look-up table.

According to the look-up table of the internal function, when x is 00 and y is 10, the output value is 1101. Further, according to the look-up table of the inversion mode internal function, when x′ is 11 that is a complement of 00 and y′ is 01 that is a complement of 10, the output value is 0010 that is a complement of 1101.

The storage unit 100 may store the look-up table of the internal function and the inversion mode internal function as illustrated in FIGS. 2 and 3. Here, the look-up table that the storage unit 100 may store is not limited to the above example, but when y=Sbox (x), the storage unit 100 may store any look-up table satisfying y′=Sbox′ (x′).

The storage unit 100 as described above may include at least one type storage medium of a flash memory type, a hard disk type, a multimedia card micro type, a card type memory (e.g., SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The controller 200 is configured to output a cipher text from a plain text and performs an encrypting operation. The controller 200 outputs the cipher text from the plain text using the encryption algorithm and the inversion mode encryption algorithm that are stored in the storage unit.

The controller 200 selects at least one of the non-inversion mode and the inversion mode prior to outputting the cipher text from the plain text using the internal function of the encryption algorithm.

The selection of the mode may be randomly performed and the probability that the controller 200 will select the non-inversion mode and the probability that the controller 200 will select the inversion mode may be the same. By doing so, half of the power traces will be correlated with the intermediate value computed using a guessing key while the other half of the power traces will be completely uncorrelated thereby steeply decreasing a correlation coefficient value.

When selecting the non-inversion mode, the controller 200 outputs the cipher text from the plain text using the encryption algorithm.

When selecting the inversion mode, the controller 200 may output a complement plain text that is a complement of the plain text from the plain text.

Next, a complement cipher text (complementary cipher text) is output from the complement plain text (complementary plain text) using the inversion mode encryption algorithm that the foregoing storage unit stores. For example, the controller 200 may output the complement cipher text from the complement plain text or from the plain text using the look-up table or a series of look-up tables.

In detail, the controller 200 uses the inversion mode internal function of the inversion mode encryption algorithm. The first value that is an input value of the inversion mode internal function first used may be the complement plain text and the first value may be plural as described with reference to FIGS. 2 and 3 and the value input along with the first value may be an encryption key.

Further, the controller 200 outputs the cipher text that is the complement of the complement cipher text from the output complement cipher text.

The case of outputting the complement plain text from the plain text and even the case of outputting the cipher text from the complement cipher text may use the look-up table that may also be stored in the foregoing storage unit.

Meanwhile, when selecting the inversion mode, the controller may also output the complement cipher text from the plain text without separately outputting the complement plain text of the plain text.

That is, the controller may not only output the complement intermediate value of the next step from the complement plain text in the inversion mode, but also output the complement intermediate value of the next step using the inversion mode internal function of the inversion mode encryption algorithm that the storage unit stores from the plain text.

The storage unit may store the inversion mode internal function for the operation of the controller.

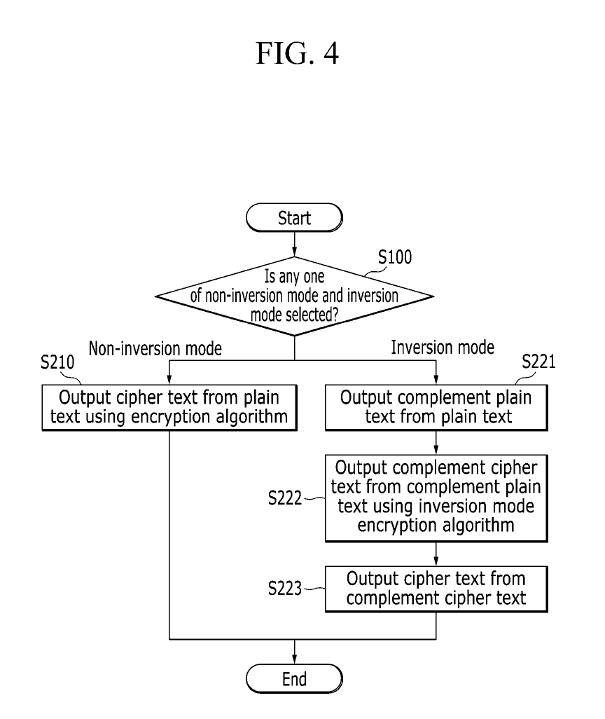

Hereinafter, an encrypting method for enhanced security against a side channel analysis will be described in detail with reference to the components described with reference to FIG. 4.

FIG. 4 is a flow chart of an encrypting method for enhanced security against a side channel analysis according to an exemplary embodiment of the present invention.

First, the controller selects any one of the non-inversion mode and the inversion mode (S100).

The non-inversion mode or the inversion mode may be randomly selected and the probability that the inversion mode will be selected and the probability that the non-inversion mode will be selected may be the same.

When the non-inversion mode is selected, the controller outputs the cipher text from the plain text using the encryption algorithm including the internal function that outputs the second value from the first value (S210).

As described above, when the non-inversion mode is selected, the encrypting operation is performed using the internal function included in the encryption algorithm. The encryption algorithm may include a plurality of internal functions. The first value that is the input value of the internal function first used may include the plain text to be encrypted and the second value that is the output value of the internal function finally used may include the cipher text.

The controller may output the cipher text from the plain text using the look-up table of the pre-stored internal function.

When the inversion mode is selected, the complement plain text that is the complement of the plain text is output from the plain text (S221).

For example, when the plain text represented by 0 and 1 is 10010, the complement plain text is 01101.

The controller outputs the complement cipher text from the complement plain text using the inversion mode encryption algorithm that includes the inversion mode internal function outputting the complement of the second value from the complement of the first value (S222).

As described above, when the inversion mode is selected, the encrypting operation is performed using the inversion mode internal function. The complement of the first value that is the input value of the inversion mode internal function first used may include the complement plain text and the complement of the second value that is the output value of the internal function finally used may include the complement cipher text.

The controller may output the complement cipher text from the complement plain text using the look-up table of the inversion mode internal function.

The controller outputs the cipher text that is a complement of the complement cipher text from the complement cipher text (S223).

In the inversion mode, the intermediate value is a complement during the encryption using the inversion mode internal function and a result value is also output as a complement, and therefore the number having the complement relationship with the result value is output.

Hereinafter, a process of encrypting a plain text according to an exemplary embodiment of the present invention will be described as a detailed example.

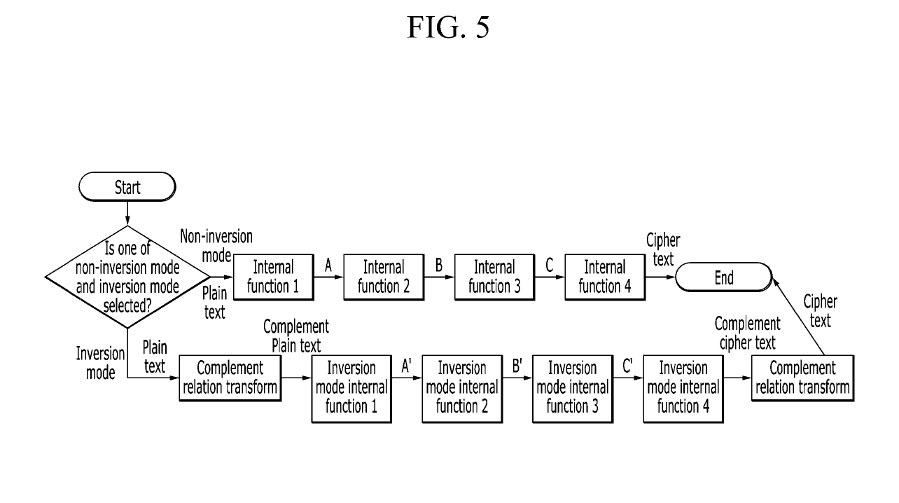

FIG. 5 is a process of encrypting a plain text to be encrypted into a cipher text according to an exemplary embodiment of the present invention.

Referring to FIG. 5, first, any one of the inversion mode and the non-inversion mode is selected. When the non-inversion mode is selected, A is output from the plain text through internal function 1, B is output from the A through internal function 2, C is output from the B through internal function 3, and the cipher text is output from the C through internal function 4.

When the inversion mode is selected, a complement relation transform (a first complement relation transform) is performed to output the complement plain text from the plain text, A′ that is a complement of A is output from the complement plain text through inversion mode internal function 1, B′ is output from the A′ through inversion mode internal function 2, C′ is output from the B′ through inversion mode internal function 3, and the complement cipher text is output from the C′ through inversion mode internal function 4. Further, a cipher text having the complement relation (complementary relation) with the complement cipher text is output from the complement cipher text through a complement relation transform (a second complement relation transform).

Meanwhile, in FIG. 5, the first complement relation transform can be integrated into the inversion mode internal function1 and the second complement relation transform can be integrated into the inversion mode internal function 4.

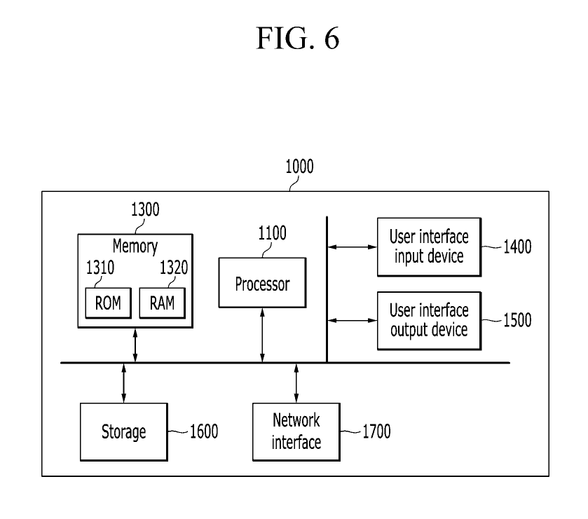

Referring to FIG. 6, a computing system 1000 may include at least one processor 1100, a memory 1300, a user interface input device 1400, a user interface output device 1500, a storage 1600, and a network interface 1700 that are connected via a bus 1200.

The processor 1100 may be a semiconductor device that executes processing on commands stored in a central processing unit (CPU), the memory 1300, and/or the storage 1600. The memory 1300 and the storage 1600 may include various kinds of volatile or non-volatile storage media. For example, the memory 1300 may include a read only memory (ROM) and a random access memory (RAM).

The method or the algorithm process that is described with reference to the exemplary embodiments disclosed in the present specification may be directly implemented by hardware and software modules executed by the processor 1100 or a combination thereof. The software module may also reside in storage media (i.e., memory 1300 and/or storage 1600) such as a RAM memory, a flash memory, a ROM memory, an EPROM memory, an EEPROM memory, a register, a hard disk, a detachable disk, and a CD-ROM. The exemplary storage medium is coupled with the processor 1100 and the processor 1100 may read information from the storage media and may write the information in the storage media. As another method, the storage medium may also be integrated with the processor 1100. The processor and the storage media may also reside in an application specific integrated circuit (ASIC). The ASIC may also reside in a user terminal. As another method, the processor and the storage media may also reside within a user terminal as individual components.

According to an exemplary embodiment of the present invention, it is possible to prevent the encryption key from being analyzed by the side channel analysis by decreasing the correlation between the intermediate value and the power value.

Meanwhile, the effects that may be achieved by the embodiments of the present invention are not limited to the above-mentioned effects. That is, other effects that are not mentioned may be obviously understood by those skilled in the art to which the present invention pertains from the following description.

In the encrypting method and apparatus using logical complement values for enhanced security against a side channel analysis, the configuration and the method of the above-mentioned exemplary embodiments are not restrictively applied. That is, all or some of the respective exemplary embodiments may be selectively combined with each other so that they may be various modified.

What is claimed is:

1. An encrypting apparatus, comprising:
a storage unit storing an encryption algorithm and an inversion mode encryption algorithm; and
a controller selecting one of an inversion mode and a non-inversion mode,
outputting a first cipher text from a plain text using the encryption algorithm when the non-inversion mode is selected, and
outputting a complement plain text that is a complement of the plain text from the plain text, outputting a complement cipher text from the complement plain text using the inversion mode encryption algorithm, and outputting a second cipher text that is a complement of the complement cipher text from the complement cipher text, when the inversion mode is selected.

2. The encrypting apparatus of claim 1, wherein:
the controller randomly selects one of the inversion mode and the non-inversion mode.

3. The encrypting apparatus of claim 1, wherein:
probability that the controller selects the inversion mode and probability that the controller selects the non-inversion mode are the same.

4. The encrypting apparatus of claim 1, wherein:
the encryption algorithm includes an internal function outputting a second value from a first value,
the storage unit stores a look-up table of the internal function, and
the controller outputs the first cipher text from the plain text using the look-up table.

5. The encrypting apparatus of claim 1, wherein:
the inversion mode encryption algorithm includes an inversion mode internal function outputting a complement of a second value from a complement of a first value,
the storage unit stores a look-up table of the inversion mode internal function, and
the controller outputs the complement cipher text from the complement plain text using the look-up table.

6. An encrypting method of an encrypting apparatus, comprising:
selecting one of a non-inversion mode and an inversion mode;
outputting a first cipher text from a plain text using an encryption algorithm, when the non-inversion mode is selected;
outputting a complement plain text that is a complement of the plain text from the plain text, when the inversion mode is selected;
outputting a complement cipher text from the complement plain text using an inversion mode encryption algorithm; and
outputting a second cipher text that is a complement of the complement cipher text from the complement cipher text.

7. The encrypting method of claim 6, wherein:
the selecting comprises randomly selecting one of the inversion mode and the non-inversion mode.

8. The encrypting method of claim 6, wherein:
probability that the inversion mode is selected and probability that the non-inversion mode is selected are the same.

9. The encrypting method of claim 6, wherein:
the encryption algorithm includes an internal function that outputs a second value from a first value, and
the outputting of the first cipher text from the plain text comprises outputting the first cipher text from the plain text using a look-up table of the internal function.

10. The encrypting method of claim 6, wherein:
the inversion mode encryption algorithm includes an inversion mode internal function outputting a complement of a second value from a complement of a first value, and
the outputting of the complement cipher text from the complement plain text comprises outputting the complement cipher text from the complement plain text using a look-up table of the inversion mode internal function.

11. An encrypting apparatus, comprising:
a storage unit storing an encryption algorithm including an internal function outputting a second value from a first value and an inversion mode encryption algorithm including an inversion mode internal function outputting a complement of the second value from a complement of the first value; and
a controller selecting one of an inversion mode and a non-inversion mode,
wherein the controller outputs a complement cipher text from a plain text using the inversion mode encryption algorithm, and outputs a first cipher text that is a complement of the complement cipher text from the complement cipher text, when the inversion mode is selected.
